(19) United States
(12) Patent Application Publication
(10) Pub. No.: US 2002/0051739 A1
(43) Pub. Date: May 2, 2002

(54) Deodorizing apparatus for doored containers

(76) Inventor: Chi-Hsiang Wang, Taipei (TW)

Correspondence Address: FRANCIS EDWARD MARINO, 394 MEREDITH NECK ROAD, MEREDITH, NH, 03253, US

(21) Appl. No.: 09/969,051

(22) Filed: Oct. 2, 2001

Related U.S. Application Data
(60) Provisional application No. 60/237,112, filed on Oct. 3, 2000.

(51) Int. Cl. G05B 1/00; B01J 19/08; G05D 1/00; B32B 5/02; B32B 27/04; B32B 27/12; G05B 17/00; A62B 7/08; B01J 19/12

(52) U.S. Cl. 422/105; 422/186.07; 422/116; 422/121

(57) ABSTRACT

An odor-eliminating apparatus that is disposed in or affixed to the inside of a container door or the underside of a container lid and adapted to emit an odor-eliminating gas every time the closed door or lid is opened and reclosed. In the preferred embodiment, the apparatus comprises a battery operated ozone-generating module adapted for attachment to the inner surface of the container lid and including an orientation sensor that reacts to the door opening/closing and triggers the module to generate a predetermined amount of ozone gas and release it into the container. The ozone gas reacts with the organic odor molecules in the container to destroy the odor molecules and create therefrom a healthful mixture of oxygen and carbon dioxide.

### FIELD OF THE INVENTION

The present invention is a deodorizing apparatus for eliminating the organic odors within containers such as trash bins, diaper pails, litter boxes, refrigerators, clothes hampers, etc., such as by exposing the odors to ozone gas.

### BACKGROUND AND OBJECTS OF THE INVENTION

The problems associated with obnoxious odors from containers such as trash bins, diaper pails, litter boxes, refrigerators, clothes hampers, and such are well known. Numerous attempts to hide, reduce and eliminate such odors have been made. It is also well known that in measured quantities, ozone is a safe and healthful gas and poses no environmental threat. It is also well known that ozone breaks down and eliminates organic odors such as those commonly associated with such containers. Prior art methods and devices for hiding, reducing and eliminating odors in such containers have consisted of dousing the insides of the containers with cover-up chemicals and aromatic gases from limited supplies. These chemicals and gases are often costly, must be maintained, and might very well be just as obnoxious to an observer as the odors they intend to cover-up.

Further, previously used deodorizing methods for such containers have maintained a constant level of deodorizing chemicals in the container at all times. This is found to be very wasteful and inefficient as such containers are just as often empty as they are full. And certain containers that are used less frequently do not require the same amount of deodorization as those used more often. No method is found in the prior are that effectively monitors the amount of use of the container and adjusts the amount of deodorization accordingly.

It is therefore an object of the present invention to provide an odor-eliminating apparatus for a lidded container that senses the actual use of the container and provides deodorization proportionate to such use.

It is another object of the invention to provide an odor-eliminating apparatus whose deodorization capabilities are unlimited and need no refilling or maintenance It is another object to provide such an odor-eliminating apparatus that eliminates odors rather than hiding them.

It is further object to provide such an odor-eliminating apparatus that focuses its deodorizing on those organic odors common to such containers as trash bins, diaper pails, litter boxes, refrigerators, clothes hampers, and which converts those obnoxious odors generally associated therewith into a healthful and natural gas mixture.

Further objects and advantages of the present invention will become apparent upon review of the following.

### SUMMARY OF THE INVENTION

The present invention comprises an odor-eliminating apparatus that is disposed in or affixed to the inside of a container door or the underside of a container lid and adapted to emit an odor-eliminating gas every time the closed door or lid is opened and reclosed. In the preferred embodiment, the apparatus comprises a battery operated ozone-generating module adapted for attachment to the inner surface of the container lid and including an orientation sensor that reacts to the door opening/closing and triggers the module to generate a predetermined amount of ozone gas and release it into the container. The ozone gas reacts with the organic odor molecules in the container to destroy the odor molecules and create therefrom a healthful mixture of oxygen and carbon dioxide.

### DESCRIPTION OF THE DRAWINGS

FIG. 1 is a top perspective view of an odor-eliminating module in accordance with the preferred embodiment of the invention.

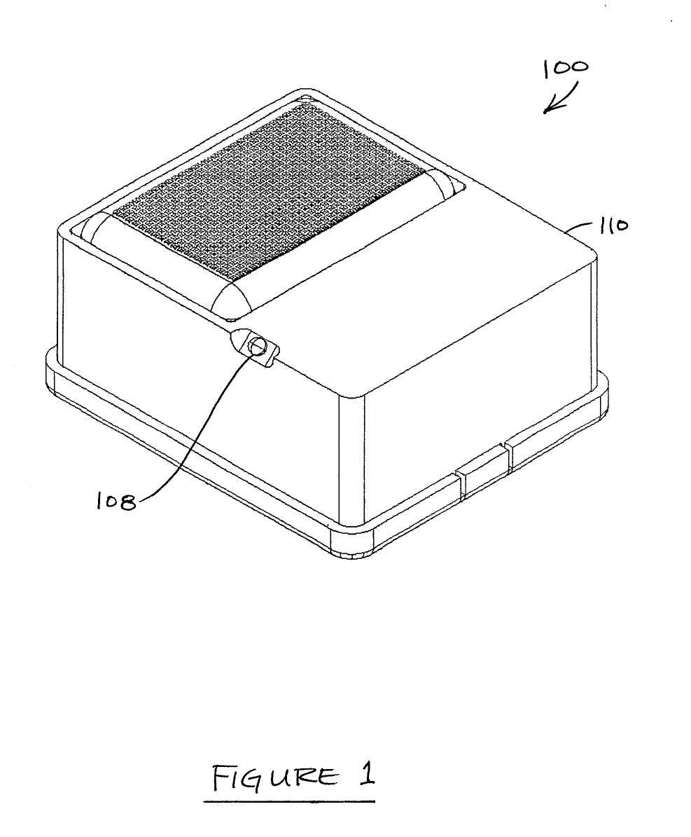

FIG. 2 is a circuit diagram of the module of FIG. 1,

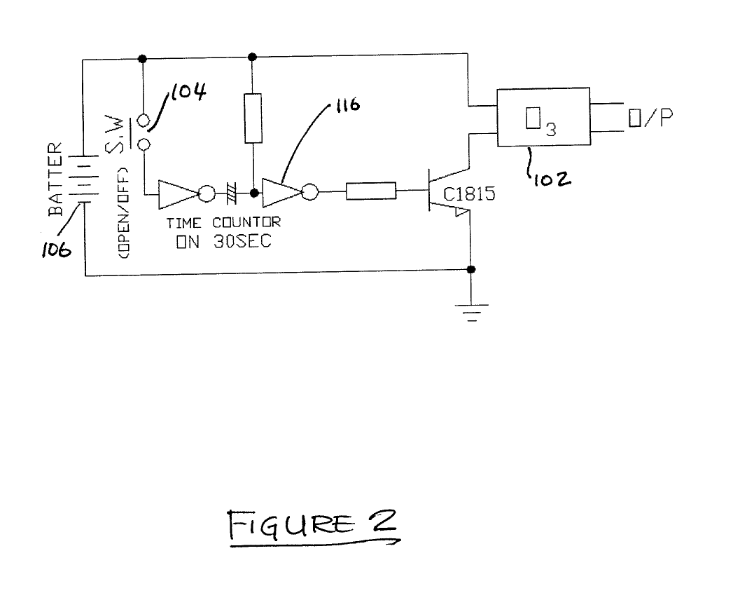

FIG. 3 is a perspective view of a trash bin having the module of FIG. 1 affixed to the underside of its lid,

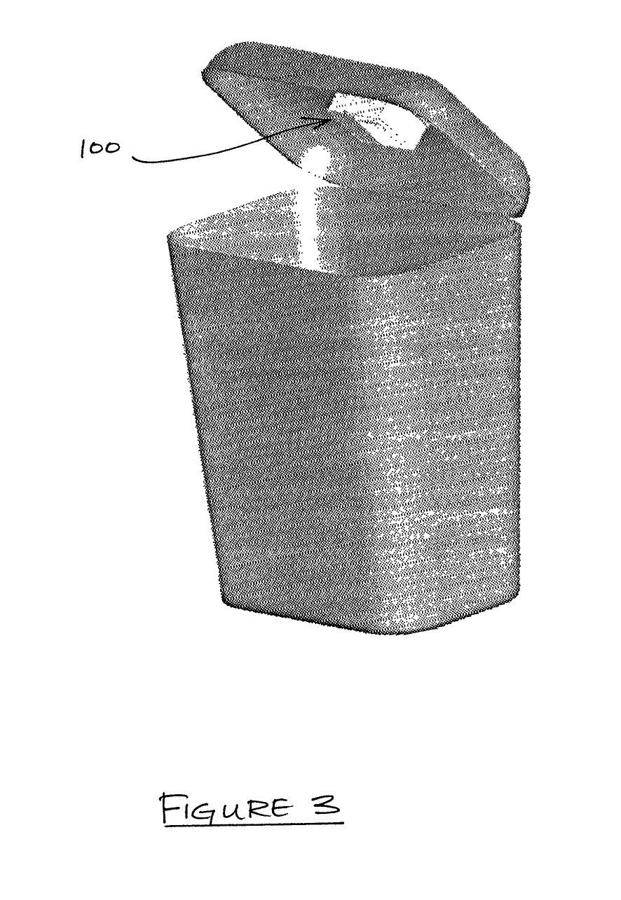

FIG. 4 is a cross-sectioned elevational view of the trash bin and module of FIG. 3,

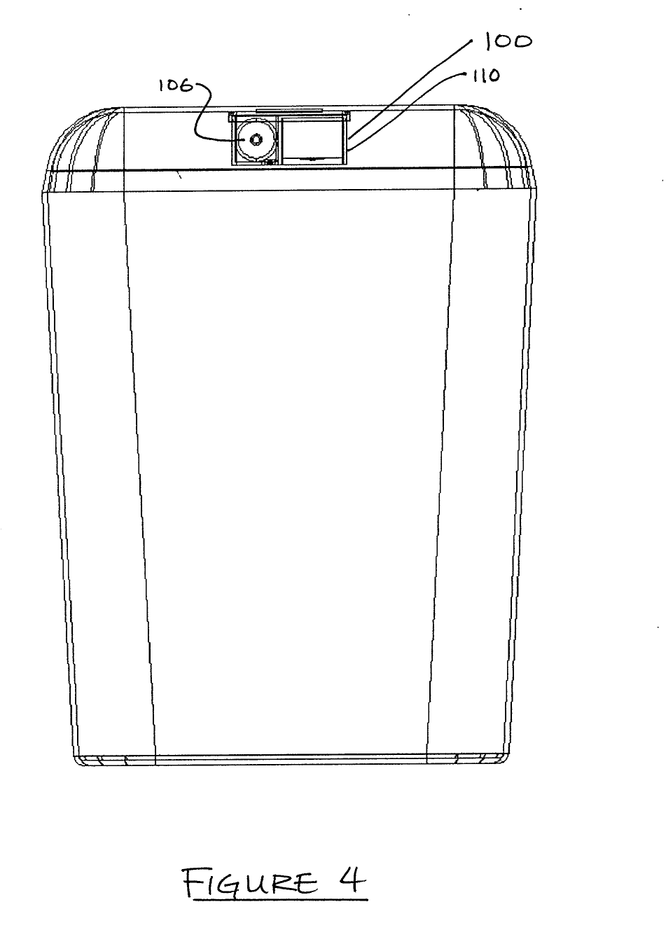

FIG. 5 is an exploded view of the module of FIG. 1,

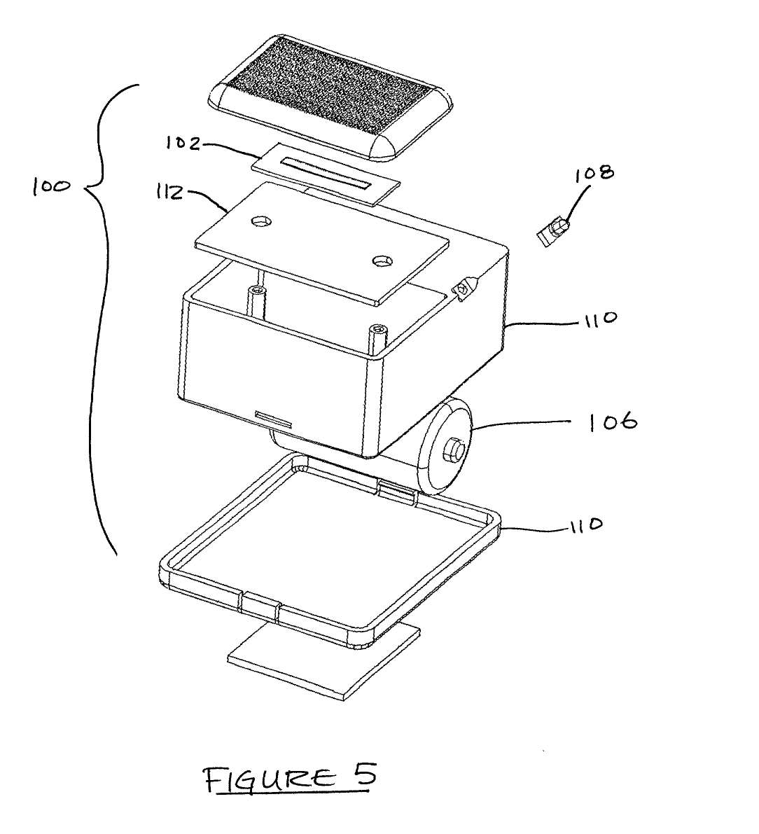

FIG. 6 is a top plan view of the module of FIG. 1,

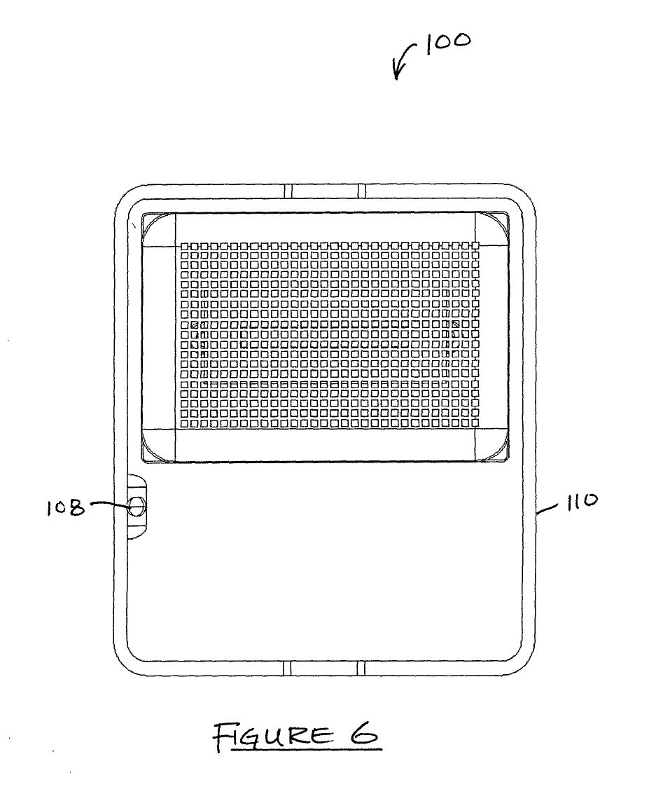

FIG. 7 is a bottom plan view of the module of FIG. 1, and

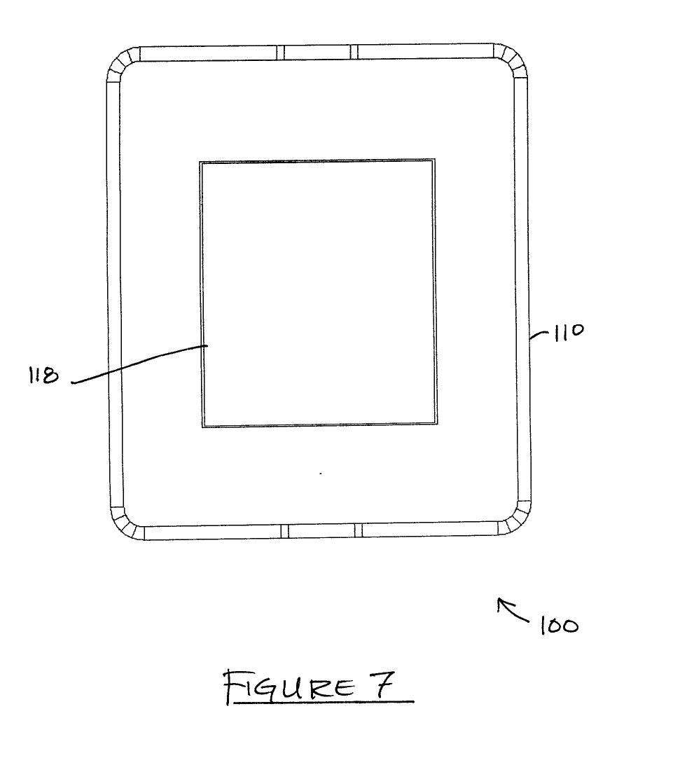

FIG. 8 is a top plan view of the interior of the module of FIG. 1.

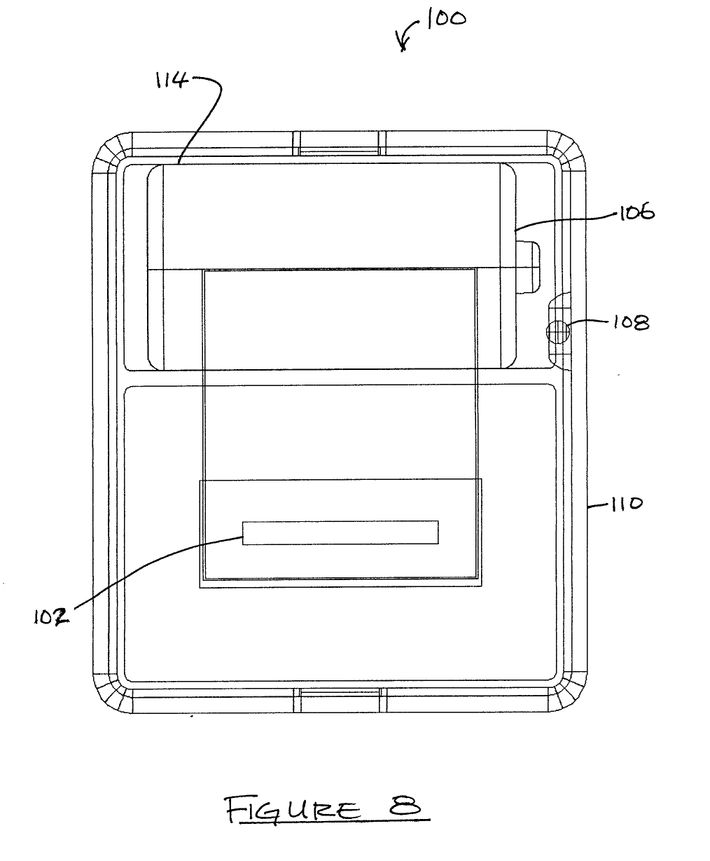

### DETAILED DESCRIPTION OF THE PREFERRED EMBODIMENT OF THE INVENTION

The present invention comprises an ozone-generating module 100 for affixing to an interior surface of a lidded or doored container, on or adjacent to the lid or door. The module includes an ozone generator 102 and a lid-opening sensor 104. The sensor of the preferred embodiment is a common motion-sensing switch that can trigger generation of ozone by the ozone generator whenever it senses a certain movement by the lid such as when the lid has been opened and reclosed. However, it is anticipated that numerous other types of sensors might be used and such are within the scope of the invention. Those include, but are not limited to; a mechanical switch with a feeler that reaches between the lid and the body of the container and actuates the ozone generator upon relative motion between the two, a motion sensing switch that senses the inertia caused by the opening and reclosing action, or a tilt switch, which actuates the ozone generator circuit as a reaction to the tilt of the switch such as may be caused when a vertically swinging lid is opened.

The ozone gas released into the compartment breaks down the odor molecules according to well-known chemical processes and converts the molecules into beneficial and harmless gases such as oxygen and carbon dioxide.

Although the preferred embodiment employs a battery 106 for power, the circuit could alternately be arranged to operate from standard 120 VAC power, or through an AC to DC adapter. The present embodiment includes a low-battery signaling LED 108 to alert the user when the battery is near depletion. Due to its intermittency of use and low power draw during use, it is found that the battery of the present embodiment will last for several months of use without need for replacement. When run from standard 120 VAC power, such a device would operate indefinitely without the need for any maintenance whatsoever.

Regardless of the type of sensor employed, once it actives the ozone generator, ozone is produced and emitted for a predetermined duration of time, sufficient to fill the interior of the container with enough ozone to deodorize the anticipated amount of odor therein. Each time that the sensor senses that the door has opened and reclosed, the ozone generator is triggered to begin the ozone-generating sequence that results in the production of a predetermined amount of ozone gas and release of the same into the container. The sensor effectively realizes the separation of the lid or door from the container body as would occur when a closed side lid or door is opened and reclosed such as would occur when a person opened a trash bin to insert trash or opened a hamper to insert soiled clothes.

It is a feature of the invention that the ozone generator does not normally produce ozone when the lid is open.

Although the preferred embodiment employs a battery 106 for power, the circuit could alternately be arranged to operate from standard 120 VAC power, or through an AC to DC adapter. Due to its intermittency of use and low power draw during use, it is found that the battery of the present embodiment will last for several months of use without need for replacement. When run from standard 120 VAC power, such a device would operate indefinitely without the need for any maintenance whatsoever.

Since ozone is a colorless and odorless gas, user comfort that the device is operating properly is provided by a low-battery sensing circuit within the device that lights a “replace battery” LED 108 if the battery voltage falls below a predetermined level. Alternately, the LED could be a normally on light which signals that the circuit is operating properly and dims when the battery is low, or a low-intensity bulb could be provided to provide both a low-battery signal and to illuminate the interior chamber of the container when opened.

The device comprises a plastic housing 110 containing such components as a PC board 112, a battery holder 114, and the aforementioned state of the art ozone generator 102. The PC board comprises the sensing device 104 that initiates the ozone production and the timer 116 to terminate that production after the predetermined period as required. The circuitry is also adapted to operate in an “automatic” mode in which a measured quantity of ozone is generated every 3 hours or 6 hours while the lid is not opened. This provides for the situation where a user leaves home for several days and the lid is left closed during that time. The circuitry prevents the generation of ozone if the sensor realizes that the lid has been left open.

The plastic body of the device is provided with a “peel & stick” backing tape 118 which allows its adhesion to the underside of a container lid. It is also anticipated that the device could be affixed to the lid by “velcro-type” tape or the device might be comprised integrally into the cover at manufacture of the container.

It should be noted that the described is simply the embodiment of the invention currently preferred by the inventor and that numerous alternative embodiment might be within the scope of the invention. As such, the rights afforded to the inventor under this patent should only be limited by the following claims.

I claim:

1. A deodorizing apparatus for use with a doored container and comprising;
an ozone-generator,
a sensor adapted and arranged for sensing opening and closing of the container's door,
a control circuit connected to said sensor and adapted to enable energization of said ozone-generator after said sensor has sensed an opening and subsequent reclosing of the container's door, wherein
said energized ozone generator releases a predetermined amount of ozone gas into said container to eliminate odors therein.

2. The deodorizing apparatus of claim 1 wherein said control circuit further comprises a timer adapted to control the release of said ozone gas for a predetermined period of time in order to limit said predetermined amount.

3. The deodorizing apparatus of claim 2 wherein said timer is further adapted to control an occasional release of said ozone gas absent an opening and subsequent reclosing of the container's door.

4. The deodorizing apparatus of claim 3 wherein said circuit is adapted to deny said occasional release when the container's door is opened.

5. The deodorizing apparatus of claim 4 where said apparatus comprises an affixable module adapted for attachment to and use in any of a multitude of pre-existing doored containers.

6. The deodorizing apparatus of claim 1 where said apparatus comprises an affixable module adapted for attachment to and use in any of a multitude of pre-existing doored containers.

7. The deodorizing apparatus of claim 6 wherein said control circuit is battery powered.

8. The deodorizing apparatus of claim 7 wherein said control circuit further comprises a timer adapted to control the release of said ozone gas for a predetermined period of time in order to limit said predetermined amount.

9. The deodorizing apparatus of claim 8 wherein said timer is further adapted to control an occasional release of said ozone gas absent an opening and subsequent reclosing of the container's door.

10. The deodorizing apparatus of claim 1 wherein said circuit is adapted to deny said occasional release when the container's door is opened.
